(19) United States
(12) Patent Application Publication
(10) Pub. No.: US 2012/0057016 A1
(43) Pub. Date: Mar. 8, 2012

(54) MULTIFUNCTIONAL WORKING PLATFORM FOR THE PROCESS OF AN IMAGE SENSOR MODULE

(75) Inventors: Tsai-Sheng Shen, Tu Cheng (TW); Han-wei Wang, Tu Cheng (TW); Jung-kuang Liu, Tu Cheng (TW)

(73) Assignee: Cheng Uei Precision Industry Co., LTD., Tu Cheng City (TW)

(21) Appl. No.: 12/876,109

(22) Filed: Sep. 4, 2010

(51) Int. Cl. H04N 7/18

(52) U.S. Cl. 348/86; 348/E07.085

(57) ABSTRACT

A multifunctional working platform for the process of an image sensor module includes a rotary disc, an electronic controlling component, a positioning device, a focusing device, a dispensing device and a solidifying device. The positioning device includes a supporting bracket and a video camera. The focusing device includes a focusing unit and a stepper motor component. The focusing unit includes a mounting base, a supporting board, a focusing wheel mechanism and a first motor. The first motor controls the focusing wheel mechanism to vertically move. The stepper motor component controls the focusing wheel mechanism to horizontally move. The dispensing device includes a mounting frame, a driving mechanism and a dispensing tube. The solidifying device includes a supporting post and a solidifying tube. The multifunctional working platform gathers functions of positioning, focusing, dispensing and solidifying as a whole thereby improving the focusing precision, the automation level and the working efficiency.

### BACKGROUND OF THE INVENTION

1. Field of the Invention

The present invention relates to a working platform, and more particularly to a multifunctional working platform for the process of an image sensor module.

2. Description of the Prior Art

A CMOS (Complementary Metal-Oxide-Semiconductor) image sensor module is an optical sensor manufactured in optoelectronic technology, and is mainly employed in low-level image products such as a digital camera, a PC camera, a mobile phone, a PDA (person digital assistance), an image telephone and so on. The CMOS image sensor module mounted into above image products can be used for focusing. Procedures, including: capturing image and positioning lens, focusing lens, dispensing glue, solidifying glue and so on, must be implemented on the CMOS image sensor module before leaving the factory. Wherein the focusing procedure is most important.

Prior technology generally adopts two methods for adjusting the focus of the CMOS image sensor module. One method of focusing can be executed by manual operation, which can set the image to be best shown. But the accuracy of focusing achieved by this method of manual operation may be varied on account of the different operators because the result of focusing is depending on individual judgments. Therefore, this method of manual operation inevitably can affect consistency of quality of the image sensor modules.

The other method of focusing is employing a focusing device capable of automatically focusing. This focusing device generally can use a motor to control a focusing wheel mechanism moving downward until the mechanism is in engagement with a lens. Then, the operation of focusing need be implemented again on the basis of comparing the parameters by the computer image processing technology.

But this prior method of automatically focusing can only control the focusing wheel mechanism to move along a single direction, so that the correction precision of compensating position and modifying angle, achieved by the focusing wheel mechanism, is not high enough and the correction value has a larger deviation, thereby reducing the precision of focusing. Moreover, because the four procedures in the process of the CMOS image sensor module are separate, the CMOS image sensor module having been processed by one of procedures need be transferred from one working platform to another working platform for receiving next procedure. Accordingly, the manufacture efficiency of this prior method is low, and the manufacture period is long. During the course of carrying the image sensor module, the focus location of the image sensor module is easy to be changed because of shaking or vibrating thereby reducing the quality thereof.

### BRIEF SUMMARY OF THE INVENTION

An object of the present invention is to provide a multifunctional working platform for the process of an image sensor module, which can be used to perform procedures of positioning, focusing, dispensing and solidifying, and has following advantages of improving the focusing precision, perfecting the machining functions, enhancing the automation level, shortening the manufacture period and enhancing the working efficiency.

To achieve the above object, in accordance with the present invention, a multifunctional working platform for the process of an image sensor module is provided. The multifunctional working platform for the process of an image sensor module comprises a rotary disc, an electronic controlling component controlling the rotary disc, a positioning device, a focusing device, a dispensing device and a solidifying device. Wherein the positioning device, the focusing device, the dispensing device and the solidifying device are surrounding the rotary disc and are sequentially arranged around the rotary disc. The rotary disc carries the image sensor module to sequentially transfer the image sensor module to the positioning device, the focusing device, the dispensing device and the solidifying device. The positioning device includes a supporting bracket and a video camera fixed on the supporting bracket. The focusing device includes a focusing unit and a stepper motor component controlling the action of the focusing unit. The focusing unit includes a mounting base, a supporting board connected to the mounting base, a focusing wheel mechanism and a first motor. The focusing wheel mechanism is fixed to the supporting board. The first motor controls the focusing wheel mechanism to vertically move, and the stepper motor component is connected to the mounting base for controlling the focusing wheel mechanism to horizontally move. The dispensing device includes a mounting frame, a driving mechanism and a dispensing tube. The driving mechanism and the dispensing tube are connected to the mounting frame. The driving mechanism drives the dispensing tube to work. The solidifying device includes a supporting post, a solidifying tube fixed to the supporting post and a covering shell used to enclose a solidifying region.

Based on the above description, the multifunctional working platform for the process of an image sensor module as provided by the present invention gathers functions of positioning, focusing, dispensing and solidifying as a whole, which is perfect. The multifunctional working platform can automatically focusing after capturing image and positioning lens, and then can automatically complete the procedures of dispensing and solidifying, whereby the focusing position of lens can avoid to be varied because of manually being taken down and placed. The present multifunctional working platform has a high automation level to largely shorten the manufacture period and enhance the working efficiency. Moreover, the focusing device can control the vertical movement of the focusing wheel mechanism by the first motor and control the horizontal movement thereof by the stepper motor component. In this way, the angle and position of the focusing wheel mechanism can be modified so that improving the focusing precision.

### BRIEF DESCRIPTION OF THE DRAWINGS

FIG. 1 is a perspective view of a multifunctional working platform for the process of an image sensor module according to one embodiment of the present invention;

FIG. 2a is a partial perspective view of the multifunctional working platform of FIG. 1;

FIG. 2b is an enlarged view of part A of FIG. 2a, and is a schematic view structure of the image sensor module;

FIG. 3 is a perspective view of a positioning device of the multifunctional working platform of FIG. 2a;

FIG. 4 is a perspective view of a focusing device of the multifunctional working platform of FIG. 2a;

FIG. 5a a partial exploded view of the focusing device of FIG. 4;

FIG. 5b an enlarged view of part B in FIG. 5a, for clearly showing a focusing wheel mechanism of the focusing device;

FIG. 6 is a side view of a focusing unit of the focusing device of FIG. 5a;

FIG. 7 is a perspective view of a first dispensing unit of a dispensing device of the multifunctional working platform of FIG. 2a;

FIG. 8 is a perspective view of a second dispensing unit of the dispensing device of the multifunctional working platform of FIG. 2a; and

FIG. 9 is an exploded perspective view of a solidifying device of the multifunctional working platform of FIG. 2a.

### DETAILED DESCRIPTION OF THE PREFERRED EMBODIMENTS

The following embodiment with reference to the accompanying drawings now has been given for detail describing the technology, the feature, the object and the effect of the present invention.

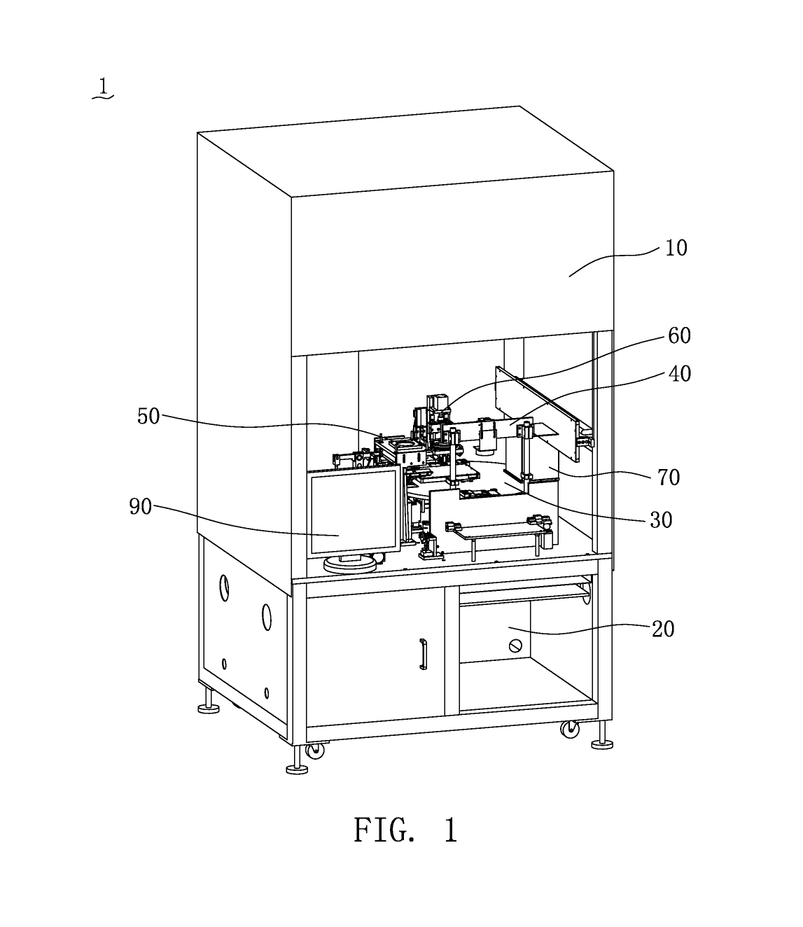

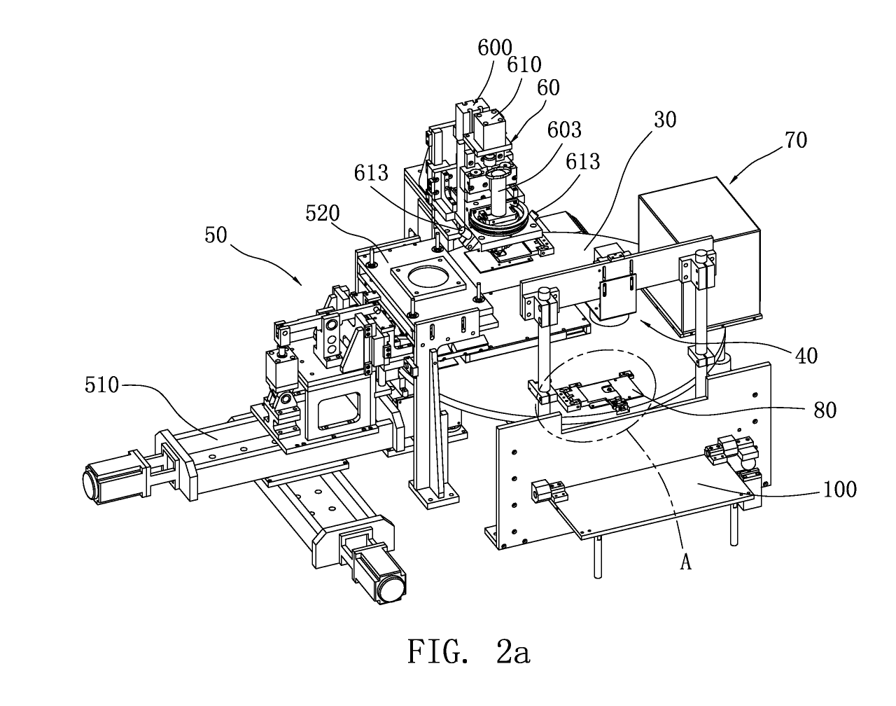

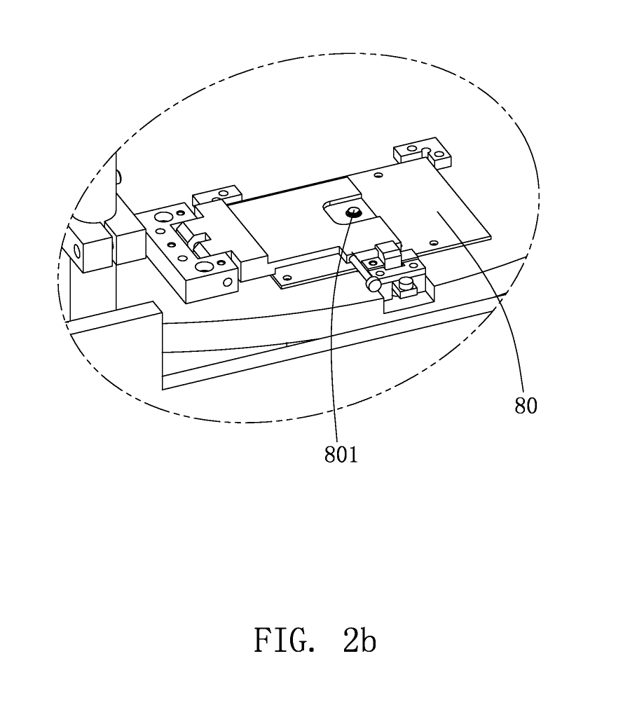

Please refer to FIGS. 1 and 2a, a multifunctional working platform 1 for the process of an image sensor module comprises a lamp box 10, an electronic controlling component 20, a rotary disc 30, a positioning device 40, a focusing device 50, a dispensing device 60 and a solidifying device 70. Wherein the positioning device 40, the focusing device 50, the dispensing device 60 and the solidifying device 70 are all surrounding the rotary disc 30 and are sequentially arranged around it. An image sensor module 80 is placed on the rotary disc 30, and is sequentially transferred to these devices 50, 60 and 70 for automatically performing the procedures of positioning, focusing, dispensing and solidifying and so on. The multifunctional working platform 1 of the present invention also comprises a computer device 90 for transmitting communication signals in the multifunctional working platform 1.

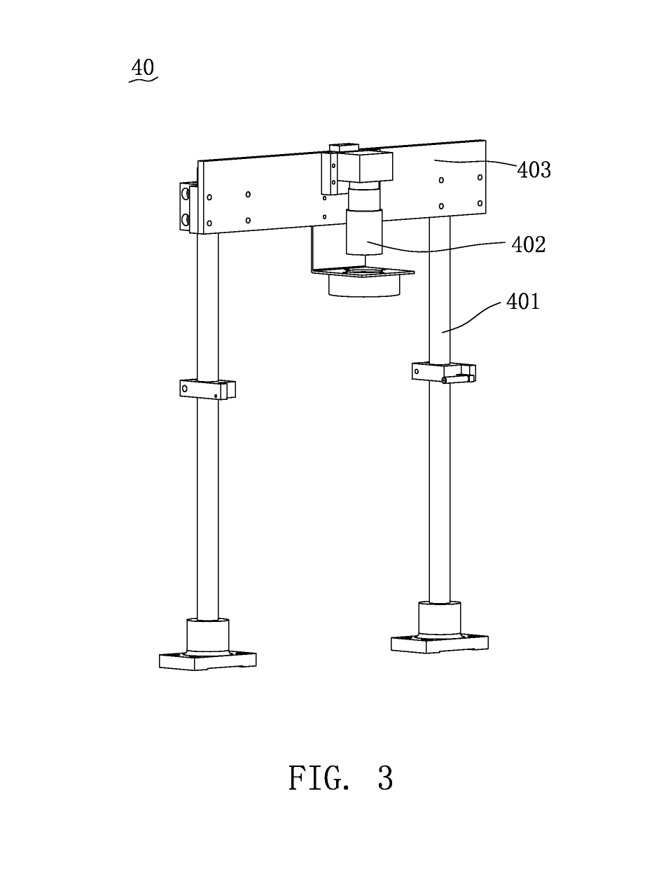

Referring to FIG. 3, the positioning device 40 located on one side of the rotary disc 30 includes a supporting bracket 401 and a video camera 402 fixed on the supporting bracket 401. Specifically, the supporting bracket 401 disposes a horizontal board 403, on the middle of which the video camera 402 is fixed. First, the image sensor module 80 including a lens 801 and some components is placed on the rotary disc 30. When performing the procedure of positioning to capture the image of the lens 801, the position of the lens 801 on the image sensor module 80 can be photographed by the video camera 402, so that parameters of the lens 801 such as deviation values (ΔX1, ΔY1) of the deviation center and an initial angle of the lens 801 can be obtained by the computer device 90 on the base of the computer image processing technology. Now these parameters can be transmitted to the focusing device 50 by the computer device 90, then the rotary disc 30 carries the image sensor module 80 to the below of the focusing device 50 for performing the next procedure.

Preferably, referring to FIG. 2a, a warning cover 100 is located on the same side with the positioning device 40 and is configured to automatically being opened or closed according to the signals of the computer device 90. After the image sensor module 80 is processed by the four procedures including positioning, focusing, dispensing and solidifying and is confirmed as a qualified product, it needs to be taken down from the rotary disc 30 and simultaneously the warning cover 100 can be automatically opened.

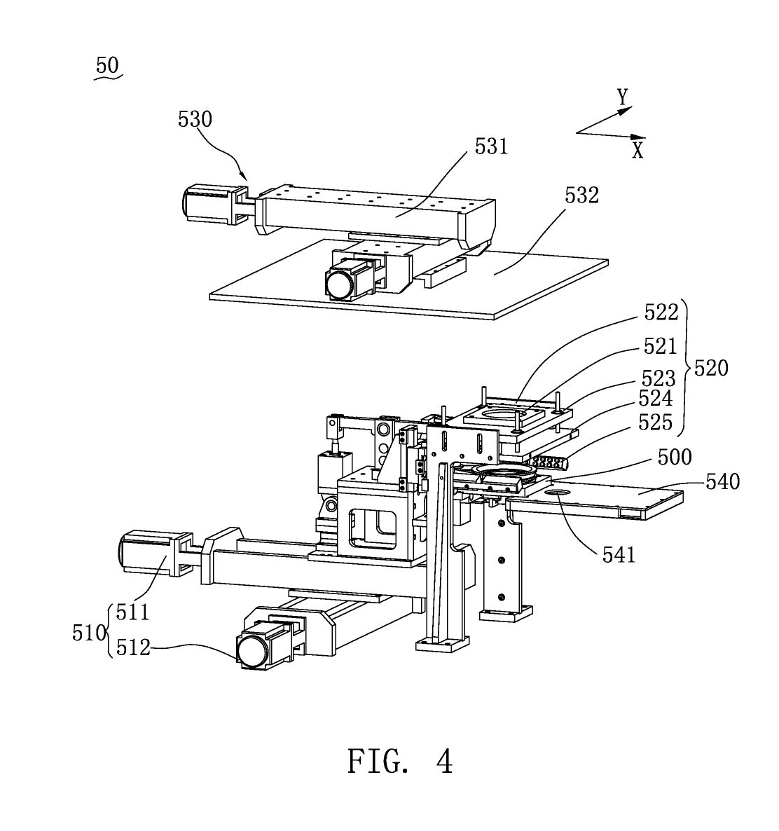

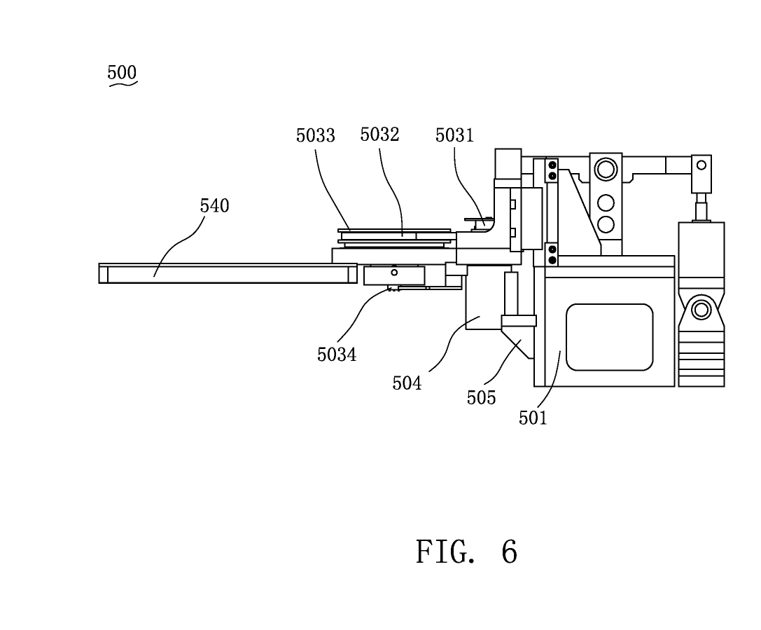

Referring to FIGS. 4 to 6, the focusing device 50 includes a focusing unit 500 and a stepper motor component 510 capable of controlling the action of the focusing unit 500. Specifically, the focusing unit 500 includes a mounting base 501, a supporting board 502 fixedly connected to the mounting base 501, a focusing wheel mechanism 503 and a first motor 504. The first motor 504 is fixed on one side of the mounting base 501 by a fastening member 505. The supporting board 502 is standing on the upper of the first motor 504 and is fixed on the mounting base 501. The focusing wheel mechanism 503 is mounted on the supporting board 502 and can be controlled by the first motor 504. Specifically, the first motor 504 controls the vertical movement of the focusing wheel mechanism 503 to adjust the angle thereof. The stepper motor component 510 includes a first stepper motor 511 and a second stepper motor 512 being perpendicular to the first stepper motor 511. The first and second stepper motors 511, 512 separately control the longitudinal and transverse movements of the focusing wheel mechanism 503 on one horizontal plane.

Specifically, the focusing wheel mechanism 503 includes a rotary wheel 5031, a first rubber ring 5032 and a focusing wheel 5033. A focusing knob 5034 is located below of the focusing wheel 5033. The rotary wheel 5031 is connected to the first motor 504. The rotary wheel 5031 is connected to the focusing wheel 5033 by the first rubber ring 5032 thereby driving the focusing knob 5034 to work. In detail, the supporting board 502 has a recess formed on one end thereof, but not shown in all FIGS. The rotary wheel 5031 is connected to the first motor 504 at the recess. The supporting board 502 has a through hole formed on the other end thereof, but not shown in all FIGS. The focusing wheel 5033 is held in the through hole.

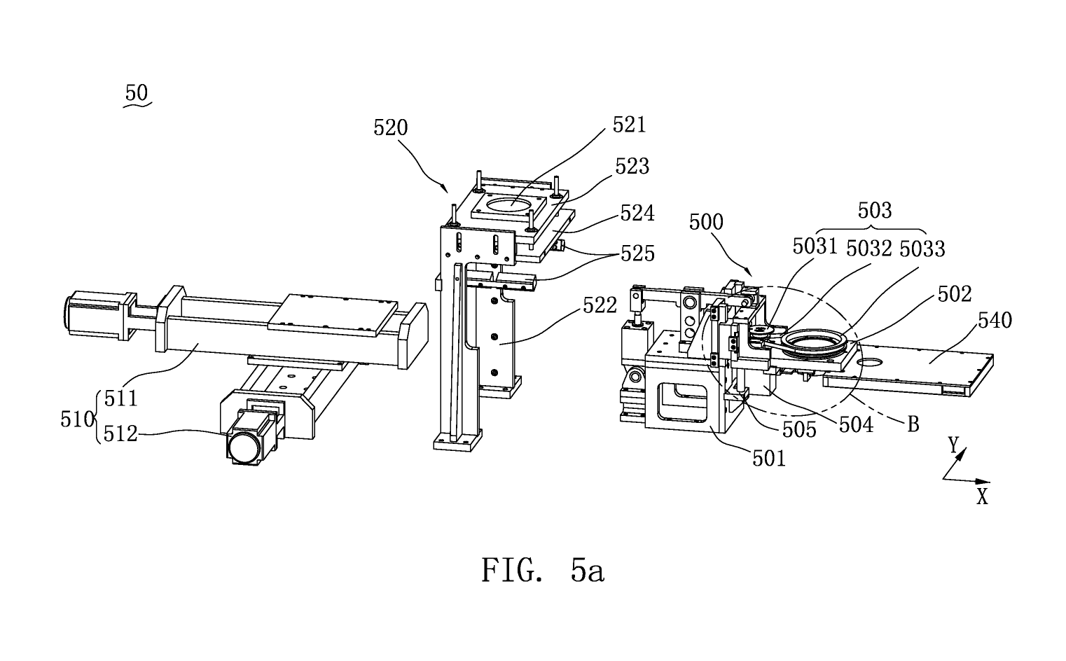

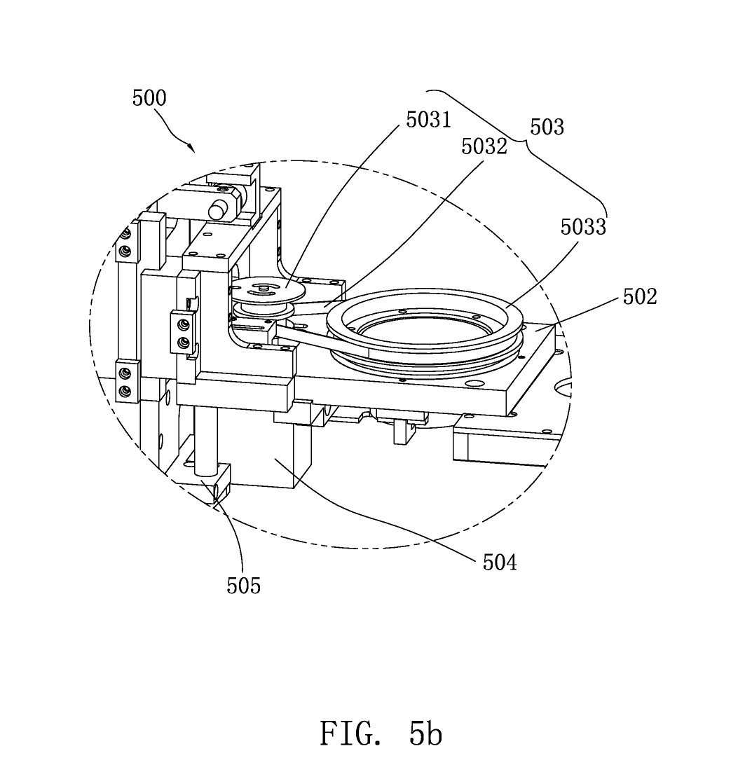

Preferably, the focusing device 50 further comprises a relay lens component 520 as shown in FIG. 5a, including a relay lens 521 and a bearing frame 522 for supporting the relay lens 521. Specifically, two bearing boards 523, 524 are mounted on the bearing frame 522 for holding the relay lens 521. Both of the two bearing boards 523, 524 have a through hole (not shown in FIG. 5a) corresponding to the position of the relay lens 521. The relay lens component 520 is placed above the focusing wheel mechanism 503. In detail, the relay lens 521 is positioned above the focusing wheel 5033 of the focusing wheel mechanism 503. Several illuminators 525 are mounted on two sides of the bearing frame 522 and located under the bearing boards 523, 524 for providing enough light during the focusing wheel 5033 focusing at close distance.

When the focusing device 50 working, the computer device 90 controls the first motor 504 and the stepper motor component 510 to operate the focusing device 50 according to the signals such as the deviation values (ΔX1, ΔY1) of the deviation center and the initial angle of the lens 801, transmitted from the positioning procedure, and the corresponding determined parameters. Specifically, the first motor 504 can bring along the focusing knob 5034 to modify the angle of the focusing knob 5034, and the first and second stepper motors 511, 512 can bring along the focusing knob 5034 to adjust the longitudinal and transverse movements of the focusing knob 5034 on the horizontal plane, namely X and Y directions. After compensation of the angle and position, the focusing knob 5034 is pressed down to grip the lens 801 of the image sensor module 80 for adjusting the focus of the lens 801.

The focusing device 50 of the present multifunctional working platform 1 further comprises a deviation-modifying unit 530 as shown in FIG. 4 for testing color pages after focusing. Generally, when the image sensor module 80 photographing the standard film, a color panel can be caused to deviate. Therefore, employing the deviation-modifying unit 530 can test whether a difference value between the color value, which is actually obtained by picking up the image, and an ideal value accords with a determined value. If the difference value does not accord with the determined value, the position of the color panel needs to be adjusted by the deviation-modifying unit 530. Specifically, the deviation-modifying unit 530 includes a modifying motor 531 and a standard board 532. The standard board 532 is connected to the modifying motor 531 and located above the focusing wheel mechanism 503. The modifying motor 531 can be used to control the horizontal movement of the standard board 532. When testing, a color board different to the standard board 532 is fixed to the standard board 532. Then a position-deviating value (ΔX2, ΔY2) of the color board can be calculated by computer image processing technology. Finally the computer device 90 controls the modifying motor 531 to modify the position of the standard board 532 according to the position-deviating value, and particularly modify the longitudinal and transverse movements of the standard board 532 on the horizontal plane, X and Y directions. During the testing procedure, a threshold value of deviation may be defined. If the position-deviating value (ΔX2, ΔY2) exceeds the threshold value of deviation, the product tested will be judged as a non-good product and it is not needed to adjust the position of the standard board 532. If the position-deviating value (ΔX2, ΔY2) does not exceed the threshold value of deviation, it will need to adjust the position of the standard board 532.

Referring to FIGS. 4 and 5a, the focusing device 50 further comprises a backlight board 540 located under and forward of the supporting board 502. The backlight board 540 has a through hole 541 (labeled in FIG. 4) formed on one end thereof. The backlight board 540 is used to test a series of defects generated after focusing. Specifically, the first stepper motor controls the backlight board 540 to move until the through hole 541 of the backlight board 540 is aligned with the upper of the image sensor module 80. Now, an ideal picture picked by the image sensor module 80 should be pure white with uniform illumination. But because of being influenced by the actual mounting process and the lens distortion, there are some differences between the actual picture and the ideal picture in a certain extent. Therefore, this process can test shading, color shading, dark-defects, blemish, and so on of the lens 801. When the dark portion (namely portion away from the through hole 541) of the backlight board 540 is moved to above the image sensor module 80, an ideal picture obtained should be pure dark. Therefore, this process can test the bright defect whether exists on the actual picture.

The focusing device 50 of the present multifunctional working platform 1 used for the image sensor module 80 has perfect functions such as being capable of automatically testing a series of defects after focusing, thereby improving the focusing precision and the product quality.

After completing to focusing by the focusing device 50, the computer device 90 transmits the focusing result to a next workstation, namely the dispensing device 60. The image sensor module 80 is transferred to below the dispensing device 60. The dispensing device 60 may be operated to perform the dispensing procedure according to the focusing result.

Referring to FIGS. 2a, 2b, 7 and 8, the dispensing device 60 comprises a first dispensing unit 600 and a second dispensing unit 610. The dispensing direction of the first dispensing unit 600 is perpendicular to the image sensor module 80, and the number of dispensing tube is one. The dispensing direction of the second dispensing unit 610 is pointed to two sides of the image sensor module 80, and the number of dispensing tube is two.

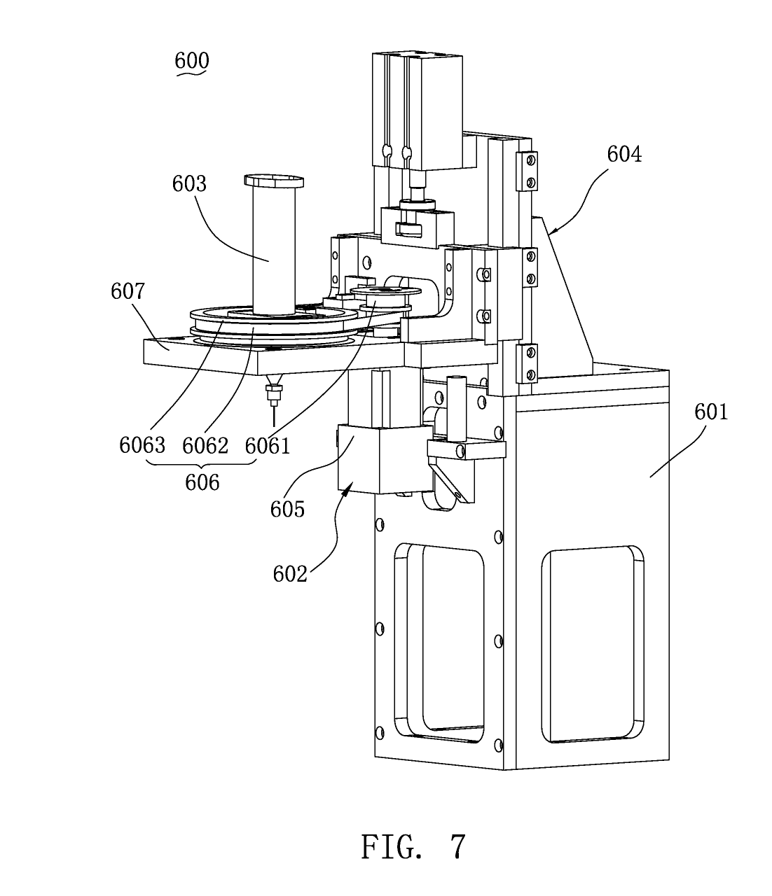

Specifically, as shown in FIG. 7, the first dispensing unit 600 comprises a first mounting frame 601, a first driving mechanism 602, a first dispensing tube 603 and a first supporting structure 604. The first driving mechanism 602 is fixedly connected to the first mounting frame 601 by the first supporting structure 604, and can control the action of the first dispensing tube 603. Specifically, the first driving mechanism 602 includes a second motor 605 and a rotary wheel mechanism 606 supported by a holding plate 607. The holding plate 607 is located above the second motor 605. The rotary wheel mechanism 606 includes an active wheel 6061, a second rubber ring 6062 and a driven wheel 6063. The active wheel 6061 is connected to the second motor 605, and is connected to the driven wheel 6063 by the second rubber ring 6062. The first dispensing tube 603 passes through the driven wheel 6063 and is connected to the driven wheel 6063, which can drive the dispensing tube 603 to work.

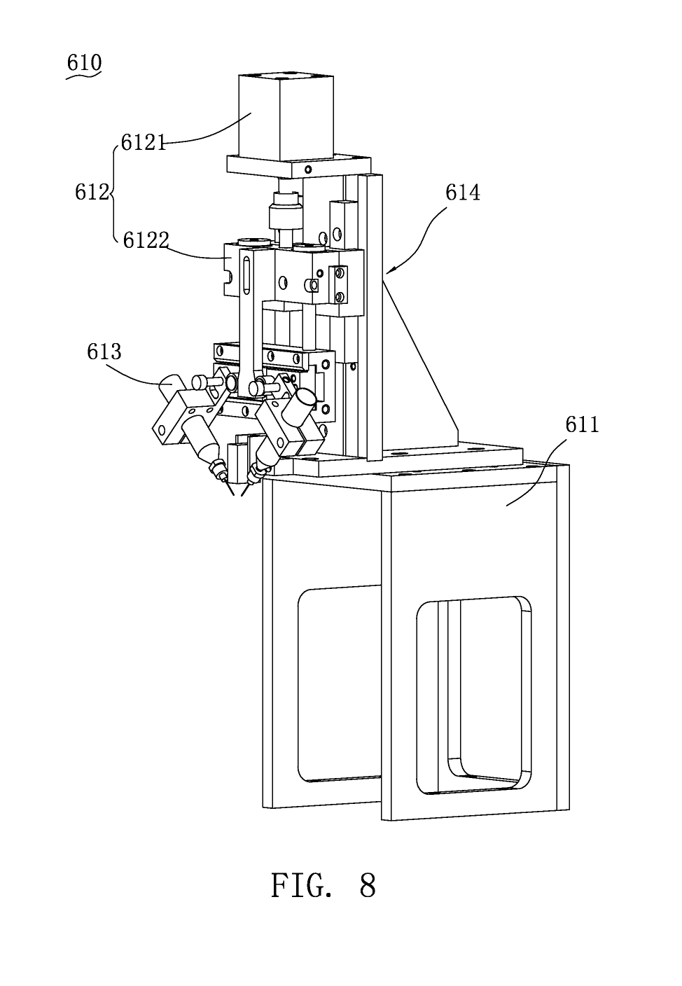

As shown in FIG. 8, the second dispensing unit 610 at least comprises a second mounting frame 611, a second driving mechanism 612, a second dispensing tube 613 and a second supporting structure 614. The second driving mechanism 602 is fixedly connected to the second mounting frame 611 by the second supporting structure 614, and can control the action of the second dispensing tube 613. Specifically, the second driving mechanism 602 includes a cylinder 6121 and a movable member 6122, one end of which is connected to the cylinder 6121 and the other end of which is connected to the second dispensing tube 613. Because the second dispensing unit 610 dispenses glue to the two sides of the image sensor module 80, the number of the second dispensing tube 613 is two, as shown in FIG. 8. The two second dispensing tubes 613 is separately and symmetrically mounted on the movable member 6122. The cylinder 6121 controls the movement of the movable member 6122 thereby driving the two second dispensing tubes 613 to work.

When the image sensor module 80 is processed by the dispensing procedure, the first and second dispensing units 600, 610 are simultaneously operated. The second motor 605 controls the first dispensing tube 603 of the first dispensing unit 600 to dispense glue over the image sensor module 80. The cylinder 6121 controls the two second dispensing tubes 613 of the second dispensing unit 610 to dispense glue to the two sides of the image sensor module 80. These designs improve the dispensing precision and the dispensing uniformity, and largely enhance the dispensing efficiency.

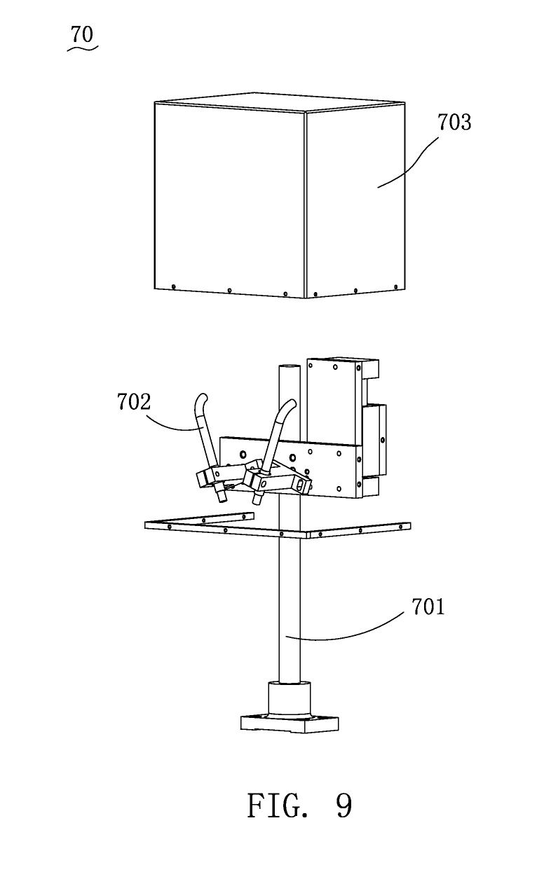

After the procedure of dispensing, the image sensor module 80 is transferred to below the solidifying device 70 for receiving the ultraviolet solidifying process. As shown in FIG. 9, the solidifying device 70 at least comprises a supporting post 701, a solidifying tube 702 and a covering shell 703. Specifically, the number of the solidifying tube 702 is two, which are separately mounted on the supporting post 701. The image sensor module 80 waiting to be solidified is located below the two solidifying tubes 702. The ultraviolet light can be transmitted from the two solidifying tubes 702. During the period of the solidifying device 70 working, the covering shell 703 always encloses the solidifying region.

When the completion of the solidifying procedure, the rotary disc 30 goes on rotating to the original position of the image sensor module 80, namely below the positioning device 40. Now, the warning cover 100 can be operated according to the final result displayed by the computer device 90. If the image sensor module 80 processed by this solidifying procedure is good product, the warning cover 100 can be automatically opened for permitting the operator to take down the good product and place a next new product on the rotary disc 30. The next new product will receive a new round machining process.

As described above, the multifunctional working platform 1 of the present invention gathers functions of positioning, focusing, dispensing and solidifying as a whole, which is perfect. The multifunctional working platform 1 can automatically focusing after capturing image and positioning lens, and then can automatically complete the procedures of dispensing and solidifying, whereby the focusing position of lens can avoid to be varied because of manually being taken down and placed. The present multifunctional working platform 1 has a high automation level to largely shorten the manufacture period and enhance the working efficiency. Moreover, the focusing device 50 can control the vertical movement of the focusing wheel mechanism 503 by the first motor 504 and control the horizontal movement thereof by the stepper motor component 510. In this way, the angle and position of the focusing wheel mechanism 503 can be modified so that improving the focusing precision.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multifunctional working platform for the process of an image sensor module comprising:
a rotary disc;
an electronic controlling component, controlling the rotary disc;
a positioning device, including a supporting bracket and a video camera fixed on the supporting bracket;
a focusing device, including a focusing unit and a stepper motor component controlling the action of the focusing unit, wherein the focusing unit includes a mounting base, a supporting board connected to the mounting base, a focusing wheel mechanism and a first motor, the focusing wheel mechanism is fixed to the supporting board, the first motor controls the focusing wheel mechanism to vertically move, and the stepper motor component is connected to the mounting base for controlling the focusing wheel mechanism to horizontally move;
a dispensing device, at least including a mounting frame, a driving mechanism and a dispensing tube, wherein the driving mechanism and the dispensing tube are connected to the mounting frame, and the driving mechanism drives the dispensing tube to work; and
a solidifying device, including a supporting post, a solidifying tube fixed to the supporting post and a covering shell used to enclose a solidifying region;
wherein the positioning device, the focusing device, the dispensing device and the solidifying device are surrounding the rotary disc and are sequentially arranged around the rotary disc, and the image sensor module is carried by the rotary disc for being sequentially transferred to the positioning device, the focusing device, the dispensing device and the solidifying device.

2. The multifunctional working platform as claimed in claim 1, wherein the stepper motor component comprises a first stepper motor and a second stepper motor being perpendicular to the first stepper motor, the first and second stepper motors separately control the longitudinal and transverse movements of the focusing wheel mechanism on a horizontal plane.

3. The multifunctional working platform as claimed in claim 1, wherein the focusing device further comprises a relay lens component, which includes a relay lens located above the focusing wheel mechanism.

4. The multifunctional working platform as claimed in claim 3, wherein the relay lens component further includes a bearing frame for supporting the relay lens, several illuminators are located under the relay lens and mounted on two sides of the focusing wheel mechanism.

5. The multifunctional working platform as claimed in claim 3, wherein the focusing device further comprises a deviation-modifying unit, which includes a modifying motor and a standard panel connected to the modifying motor and located above the focusing wheel mechanism, the modifying motor controls the standard board to horizontally move.

6. The multifunctional working platform as claimed in claim 1, wherein the focusing device further comprises a backlight board located under and forward of the supporting board.

7. The multifunctional working platform as claimed in claim 1, further comprising a computer device, used to transmit communication signals to the positioning device, the focusing device, the dispensing device and the solidifying device.

8. The multifunctional working platform as claimed in claim 7, wherein a warning cover is disposed on an edge of the rotary disc and located on one side of the positioning device, the warning cover is configured to automatically being opened or closed according to the signals of the computer device.

9. The multifunctional working platform as claimed in claim 1, wherein the focusing wheel mechanism comprises a rotary wheel, a first rubber ring, a focusing wheel and a focusing knob disposed on the focusing wheel, the rotary wheel is connected to the first motor, and the rotary wheel is connected to the focusing wheel by the first rubber ring for driving the focusing knob to work.

10. The multifunctional working platform as claimed in claim 1, wherein the dispensing device comprises a first dispensing unit and a second dispensing unit, the first dispensing unit includes a first mounting frame, a first driving mechanism and a first dispensing tube, the first driving mechanism includes a second motor and a rotary wheel mechanism, the rotary wheel mechanism includes an active wheel, a second rubber ring and a driven wheel, the driven wheel is connected to the first dispensing tube, the active wheel is connected to the second motor, the active wheel is connected to the driven wheel by the second rubber ring for driving the first dispensing tube to work, the second dispensing unit includes a second mounting frame, a second driving mechanism and a second dispensing tube, the second driving mechanism includes a cylinder and a movable member, one end of the movable member is connected to the cylinder and the other end thereof is connected to the second dispensing tube.
